(19) United States
(12) Patent Application Publication
(10) Pub. No.: US 2009/0048840 A1
(43) Pub. Date: Feb. 19, 2009

(54) DEVICE FOR CONVERTING INSTANT MESSAGE INTO AUDIO OR VISUAL RESPONSE

(76) Inventor: Teng-Feng LIN, San Chung City (TW)

Correspondence Address: LEONG C LEI, PMB # 1008, 1867 YGNACIO VALLEY ROAD, WALNUT CREEK, CA, 94598, US

(21) Appl. No.: 11/837,545

(22) Filed: Aug. 13, 2007

(51) Int. Cl. G10L 13/00

(52) U.S. Cl. 704/260; 704/E15.043

(57) ABSTRACT

The conversion device is connected, by a wired or wireless means, to an input/output port of a computing device installed with an instant messaging software. As instant messages are exchanged, the conversion device is activated by the instant messaging software to produce audio and/or visual responses in accordance with specific texts, symbols, and graphical images contained in the messages received. The conversion device could have an appealing appearance such as a doll, a puppet, or a toy figure. The conversion device can further contain at least an actuation mechanism such that, when activated, the conversion device sends a specific signal to the instant messaging software which encodes and packages the signal into a message and delivers the message to a remote computing device.

(a) Technical Field of the Invention

The present invention generally relates to instant messaging, and more particularly to a conversion device capable of producing audio and/or visual responses in accordance with specific texts, symbols, and graphical images contained in received instant messages.

(b) Description of the Prior Art

Instant messaging (IM) has become widely popular in recent years and has also become a major means of communications. Instant messaging is a form of real-time communication between two or more people based on typed text. The text is conveyed via computers connected over a network such as the Internet.

To make the communication more interesting, recent instant messaging applications allow users to exchange symbols (such as a happy face) and graphical images (such as a video clip), in addition to the typed text. However, these symbols and graphical images are only two dimensional and therefore less appealing.

### SUMMARY OF THE INVENTION

The primary purpose of the present invention is to provide a novel conversion device to deliver vivid responses in accordance with specific texts, symbols, or graphical images received in instant messages.

The conversion device is connected, by a wired or wireless means, to an input/output port of a computing device installed with an instant messaging software. As instant messages are exchanged, the conversion device is activated by the instant messaging software to produce audio and/or visual responses such as movements of parts, audible sounds, and/or flashing lights in accordance with specific texts, symbols, or graphical images contained in the messages received. The conversion device could have an appealing appearance such as a doll, a puppet, or a toy figure.

The conversion device can further contain at least an actuation mechanism such that, when activated, the conversion device sends a specific signal to the instant messaging software which encodes and packages the signal into a message and delivers the message to a remote computing device where the same device there is able to produce a corresponding audio and/or visual response.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram showing a device according to an embodiment of the present invention.

FIG. 2 is a schematic diagram showing a device according to another embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

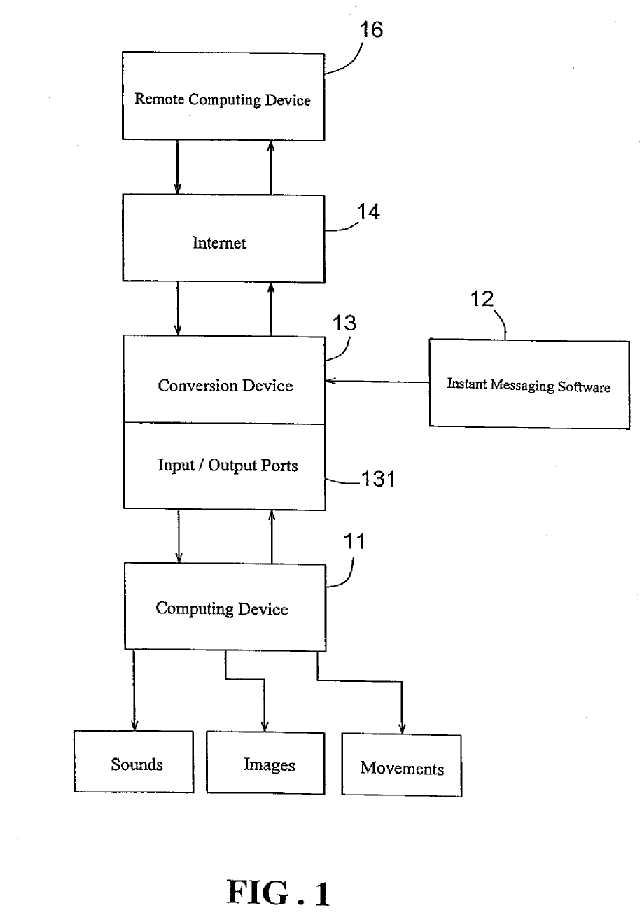

As shown in FIG. 1, a device 11 according to an embodiment of the present invention is connected to an input/output port 131 of a computing device 13 which is in turn connected to the Internet 14. The computing device 13 is installed with a instant messaging software 12 and, by running the instant messaging software 12, a first user (not shown) of the computing device 13 is able to interact with a second user (not shown) running a corresponding copy of the instant messaging software 12 (not shown) on a remote computing device 16 also connected to the Internet 14.

As the first and second users exchange messages, the conversion device 11 is activated by the instant messaging software 12 on the computing device 13 to produce audio and/or visual responses such as movements of parts, audible sounds, and/or flashing lights in accordance with specific texts, symbols, and graphical images contained in the messages received by the instant messaging software 12.

The conversion device 11 could have an appealing appearance such as a doll, a puppet, or a toy figure. When the specific texts, symbols, and graphical images are received, the instant messaging software 12 sends corresponding triggers to the conversion device 11 via the input/output port 131. Upon receiving a specific trigger, the conversion device 11 could make a smiling face, nod the head, wave a hand, or shake a tail, etc., or the conversion device 11 could produce a sound of laughter, a crying sound, a musical sound, or a sentence of speech, etc., or the conversion device 11 could turn on or flash a lamp (not shown) of the conversion device 11.

The input/output port 131 could be a wired one such as a Universal Serial Bus (USB) port, or a wireless one such as infrared or Bluetooth port. The conversion device 11 therefore has a corresponding interface mechanism for connection to the input/output port 131 via, for example, a USB cable or radio signals.

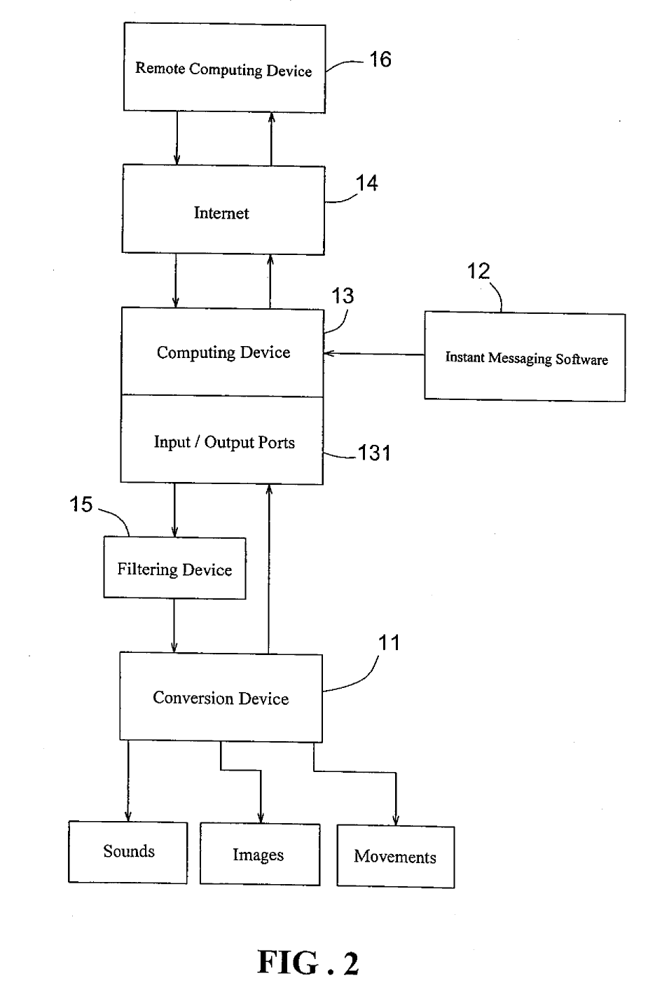

As shown in FIG. 2, a device 11 according to another embodiment of the present invention further contains a filtering device 15 which is shown as separated from the conversion device 11 (for example, inside the computing device 13). However, in alternative embodiments, the filtering device 15 can also be an integral part of the conversion device 11. The filtering device 15 is positioned between the computing device 13 and the conversion device 11 and can be configured that only triggers from a specific remote computing device 16 are allowed to pass and reach the conversion device 11. As such, the conversion device 11 produces audio and/or visual responses only when some second user on a specific remote computing device 16 issues messages containing the specific texts, symbols, and graphical images.

The computing device 13 can be any appropriate device capable of connecting to the Internet 14 and executing the instant messaging software 12. Typical examples include, but are not limited to, a desktop computer, a notebook or laptop computer, a cellular phone, or a personal digital assistance (PDA), etc.

A device 11 can further contains at least an actuation mechanism such as a button (not shown). When the actuation mechanism is activated by the first user, the conversion device 11 sends a specific signal corresponding to the button to the instant messaging software 12 of the computing device 13 via the input/output port 131. The instant messaging software 12 encodes and packages the signal into a specific text, symbol, or graphical images in a message and delivers the message to the remote computing device 16 via the Internet 14. If the remote computing device 16 is also equipped with a device 11, the conversion device 11 connected to the remote computing device 16 is then able to produce corresponding audio and/or visual responses as described above.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A device connected to an input/output port of a computing device connected to the Internet, said computing device running an instant messaging software interacting with another instant messaging software running on a remote computing device connected to the Internet; wherein said device is activated by a trigger from said instant messaging software via said input/output port to produce an audio or visual response in accordance with a specific text, symbol, or graphical images contained in the messages received by said instant messaging software.

2. The conversion device according to claim 1, wherein said device is connected to said input/output port by a cable.

3. The conversion device according to claim 1, wherein said device is connected to said input/output port by a wireless means.

4. The conversion device according to claim 1, wherein said device comprises a filtering device allowing said only triggers from a specific remote computing device to reach said device.

5. The conversion device according to claim 4, wherein said filtering device is an integral part of said device.

6. The conversion device according to claim 4, wherein said filtering device is inside said computing device.

7. The conversion device according to claim 1, wherein said device comprises an actuation means that, when activated, said device sends a signal to said instant messaging software which packages said signal in a message as a specific text, symbol, or graphical images and sends said message to a remote computing device.
